(19) United States
(12) Patent Application Publication
(10) Pub. No.: US 2026/0092871 A1
(43) Pub. Date: Apr. 2, 2026

(54) SEALED LASER INDUCED BREAKDOWN SPECTROSCOPIC SENSING SYSTEM AND APPLICATIONS THEREOF

(71) Applicant: METROLASER, INC., Laguna Hills, CA (US)

(72) Inventors: Yue Wu, Mission Viejo, CA (US); Jacob George, Downey, CA (US)

(21) Appl. No.: 19/332,601

(22) Filed: Sep. 18, 2025

Related U.S. Application Data
(60) Provisional application No. 63/702,036, filed on Oct. 1, 2024.

(51) Int. Cl. G01N 21/71

(52) U.S. Cl. CPC G01N 21/718; G01N 2201/0612

(57) ABSTRACT

A system and a method for spectroscopic sensing are provided for chemical and molecular species detections and trace concentration measurements as a standalone unit. The system may include a laser module configured for producing a laser beam capable of creating a plasma plume of a sample, the laser module comprising a Nd:YAG rod and diode lasers that are placed radially surrounding the Nd:YAG rod, wherein the diode lasers are configured to generate light having a spectral band width that overlaps absorption bands of Nd; a detector module configured for identifying elemental and trace chemicals from the plasma plume; and a computing module configured to acquire, store, and/or output data from the detector module. The disclosed system may be tightly sealed in a metal housing suitable for field applications in harsh environments for long durations, such as in subsurface conditions, in a high pressure and high temperature, or underwater.

### CROSS-REFERENCE TO RELATED APPLICATION

This application claims priority to U.S. Patent Application No. 63/702,036, filed Oct. 1, 2024, all of which is incorporated by reference herein in its entirety.

### FIELD OF INVENTION

Embodiments of the present disclosure relate generally to spectroscopic systems, and more particularly, for example, to a stand-alone spectroscopic sensing system and applications thereof.

### BACKGROUND

Laser-induced breakdown spectroscopy (LIBS)-based sensing is a versatile and novel non-destructive analytical technique. Although a LIBS-based sensing system may require minimal sample preparation while offering multi-element detection and the ability to perform in-situ measurements suitable for real-time applications, this technique suffers from poor repeatability, matrix effects, and limited sensitivity compared to other techniques. While some portable LIBS-based systems are available, the overall cost, complexity, and capabilities of the currently available systems can be a barrier to a wide adoption of such versatile analytical technique. Thus, there is a need for an improved LIBS-based sensing system that is highly miniaturized and cost-efficient yet still offers versatile chemical detections and trace concentration measurements.

### SUMMARY

In accordance with various embodiments, a spectroscopic sensing system is provided. In one or more embodiments, the disclosed spectroscopic sensing system may be used for chemical and molecular species detections and trace concentration measurements as a standalone unit. In one or more embodiments, the system may include a diode side-pumping laser source capable of megawatt-level laser output and high single pulse energy, which can enable generation, and detection, of high-quality Laser Induced Breakdown spectroscopic (LIBS) signals and at low limits of detection threshold. The disclosed spectroscopic sensing system may be operable using a portable power unit, such as a battery and then can operate in a low-power consumption mode. In one or more embodiments, the disclosed spectroscopic sensing system may be tightly sealed in a metal housing suitable for field applications in harsh environments, designed for deployment for long durations, in subsurface conditions, such as those involving a high pressure and high temperature, or underwater under high pressure.

In one or more embodiments, a system is provided. The system may include a laser module configured for producing a laser beam capable of creating a plasma plume (which may include ionized, and excited, atoms and molecules) of a sample, the laser module comprising a Nd:YAG rod and a plurality of diode lasers that are placed radially surrounding the Nd:YAG rod, wherein the plurality of diode lasers are configured to generate light having a spectral band width that overlaps absorption bands of Nd; a detector module configured for identifying elemental and trace chemicals from the plasma plume (by detecting and identifying optical emissions from ionized/excited atoms/molecules); and a computing module configured to acquire, store, and/or output data from the detector module.

In one or more embodiments of the system, the detector module may include a spectral filter configured for spectral analysis of the plasma plume. In one or more embodiments, the detector module may include a plurality of detectors, and wherein each detector comprises a photomultiplier tube.

In one or more embodiments, the system may further include a housing, and the laser module, the detector module, and the computing module are disposed within the housing. In one or more embodiments, the housing may include an opening that allows transmission of the laser beam from the laser module and reception of an emitted light from the plasma plume.

In one or more embodiments, the system may further include an optical window disposed within the opening of the housing, and wherein the optical window is transparent to both the laser beam from the laser module and the emitted light from the plasma plume.

In one or more embodiments, the system may further include a battery module comprised within the housing, and the battery module may be configured to provide power to the laser module, the detector module, and the computing module.

In one or more embodiments, the plurality of diode lasers may be positioned radially surrounding the Nd:YAG rod and spaced apart at equidistant from one another. In one or more embodiments, the plurality of diode lasers may be positioned about the Nd:YAG rod in a stacked layer configuration having at least two layers along a length of the Nd:YAG rod, and wherein each of the at least two layers may include at least two diode lasers positioned at equidistant radially from one another within the layer.

In one or more embodiments, the at least two diode lasers in adjacent layers of the at least two layers may be staggered such that the at least two diode lasers in a first layer is staggered with respect to the at least two diode lasers in a second layer. In one or more embodiments, the stacked layer configuration may include three layers along the length of the Nd:YAG rod, wherein each of the three layers comprises three diode lasers that are positioned at 120 degrees radially apart from one another within the layer. In one or more embodiments, three diode lasers of a first layer of the three layers may be staggered with respect to three diode lasers of a second layer of the three layers.

In one or more embodiments, the laser module may include a passive Q-switch configured as a saturable absorber. In one or more embodiments, the passive Q-switch may include a Cr:YAG crystal and the Cr:YAG crystal may be disposed at one end of the Nd:YAG rod.

In accordance with various embodiments, a method for spectroscopic sensing is provided. In one or more embodiments, the disclosed method may be used for chemical and molecular species detections and trace concentration measurements. The method may include providing a Laser Induced Breakdown spectroscopic (LIBS) sensing system comprising a laser module, wherein the laser module comprises a Nd:YAG rod configured for side-pumping via a plurality of diode lasers positioned radially surrounding the Nd:YAG rod; creating a plasma plume (which may include ionized/excited atoms/molecules) from a sample using a laser beam generated from the laser module of the LIBS sensing system; identifying, via the LIBS sensing system, elemental and trace chemicals from the optical emission of the laser-induced plasma plume; and generating, via the LIBS sensing system, output data based on the identified elemental and trace chemicals.

In one or more embodiments of the disclosed method, identifying the elemental and trace chemicals from the plasma plume may include spectral analysis of the plasma plume via a spectral filter or one or more detectors each comprising a photomultiplier tube.

In one or more embodiments, the LIBS sensing system may include a housing, the laser module, a detector module, a computing module, and a battery module. In one or more embodiments, the laser module, the detector module, the computing module, and the battery module may be disposed within the housing. In one or more embodiments, the housing may include an optical window that allows transmission of the laser beam from the laser module and reception of an emitted light from the plasma plume.

In one or more embodiments, the plurality of diode lasers may be positioned radially about the Nd:YAG rod at equidistant from one another. In one or more embodiments, the plurality of diode lasers may be positioned about the Nd:YAG rod in a stacked layer configuration having at least two layers along a length of the Nd:YAG rod, wherein each of the at least two layers comprises at least two diode lasers positioned at equidistant radially from one another within the layer. In one or more embodiments, the at least two diode lasers in adjacent layers of the at least two layers may be staggered such that the at least two diode lasers in a first layer is staggered with respect to the at least two diode lasers in a second layer. In one or more embodiments, the stacked layer configuration may include three layers along the length of the Nd:YAG rod, wherein each of the three layers may include three diode lasers that are positioned at 120 degrees radially apart from one another within the layer. In one or more embodiments, three diode lasers of a first layer of the three layers may be staggered with respect to three diode lasers of a second layer of the three layers.

In one or more embodiments, the laser module may include a Cr:YAG crystal, which functions as a passive Q-switch or a saturable absorber. In one or more embodiments, the Cr:YAG crystal may be disposed at one end of the Nd:YAG rod.

### BRIEF DESCRIPTION OF THE DRAWINGS

For a more complete understanding of the principles disclosed herein, and the advantages thereof, reference is now made to the following descriptions taken in conjunction with the accompanying drawings.

FIGS. 1A and 1B illustrate an embodiment of a Laser Induced Breakdown spectroscopic (LIBS) sensing system, in accordance with various embodiments.

FIG. 1C depicts a schematic depiction of the LIBS plasma emission detection mechanism of the LIBS sensing system, in accordance with various embodiments.

FIGS. 2A, 2B, 2C, and 2D illustrate an example embodiment of a laser module in cross-sectional views, in accordance with various embodiments.

FIGS. 3A, 3B, and 3C illustrate an example embodiment of a laser module in cross-sectional views, in accordance with various embodiments.

FIGS. 4A, 4B, 4C, and 4D illustrate an example embodiment of a laser module in cross-sectional views, in accordance with various embodiments.

FIGS. 5A, 5B, 5C, and 5D illustrate an example embodiment of a laser module in cross-sectional views, in accordance with various embodiments.

FIGS. 6A, 6B, and 6C illustrate an example embodiment of a laser module in cross-sectional views, in accordance with various embodiments.

FIGS. 7A, 7B, 7C, and 7D illustrate an example embodiment of a laser module in cross-sectional views, in accordance with various embodiments.

FIGS. 8A, 8B, 8C, and 8D illustrate an example embodiment of a laser module in cross-sectional views, in accordance with various embodiments.

FIGS. 9A, 9B, and 9C illustrate an example embodiment of a laser module in cross-sectional views, in accordance with various embodiments.

FIGS. 10A, 10B, 10C, and 10D illustrate an example embodiment of a laser module in cross-sectional views, in accordance with various embodiments.

FIG. 11 depicts a block diagram illustrating an example computer system with which embodiments of the disclosed system and method may be implemented, in accordance with various embodiments.

FIG. 12 illustrates a flowchart of a method for spectroscopic sensing, in accordance with one or more embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

In accordance with various embodiments, a spectroscopic sensing system and a method for spectroscopic sensing using the system are described. The disclosed spectroscopic sensing system and the method thereof can be used for chemical and molecular species detections and trace concentration measurements. In one or more embodiments, the disclosed spectroscopic sensing system may include a diode side-pumping laser source capable of megawatt-level laser output and high single pulse energy, which can enable generation and detection of high-quality Laser Induced Breakdown spectroscopic (LIBS) signals and at low limits of detection threshold. The disclosed spectroscopic sensing system may be operable using a portable power unit, such as a battery and then can operate in a low-power consumption mode.

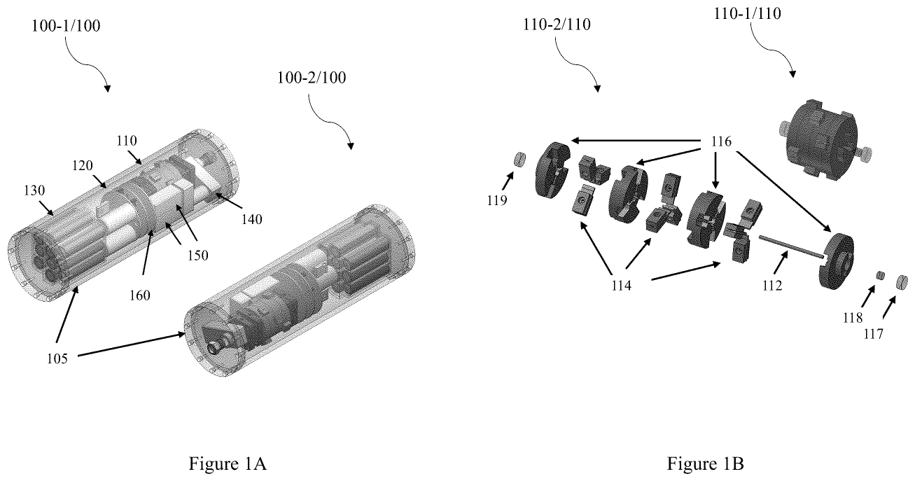

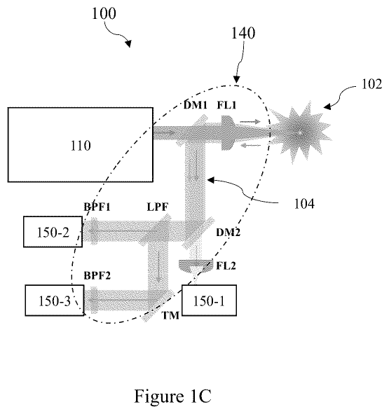

Various embodiments disclosed herein provide the disclosed spectroscopic sensing system and one or more methods thereof, the disclosures of which are described in further detail with respect to FIGS. 1-12.

FIGS. 1A and 1B illustrate an embodiment of a laser induced breakdown spectroscopic (LIBS) sensing system 100, in accordance with various aspects of the present disclosure. FIG. 1A shows a first (rear) perspective view 100-1 and a second (front) perspective view 100-2 of the sensing system 100. As described herein, the LIBS sensing system 100 can be a versatile analytical tool that utilizes a focused laser beam to create a plasma plume (which may include ionized, and excited, atoms and molecules) from a sample material. In other words, the plasma plume refers to a plume of ionized/excited atoms and in some instances, recombined molecules from such atoms. In one or more embodiments, the LIBS sensing system 100 shown in FIG. 1A may be tightly sealed (e.g., as a sealed-LIBS module) by packaging in a housing 105 (e.g., a cylindrical shape metal tube or simply a “metal housing”) suitable for field applications in harsh environments. Various housing configurations for the housing 105 may be employed beyond the cylindrical metal design, including rectangular, hexagonal, or custom-shaped housings optimized for specific deployment scenarios. The housing materials may include corrosion-resistant alloys such as titanium, Inconel, or specialized stainless-steel grades for extreme environment applications. Pressure ratings may be customized from standard atmospheric pressure resistance up to 10,000 psi or higher for deep subsurface or deep-sea applications. The sealing mechanisms may incorporate multiple redundant seals, pressure compensation systems, or active pressure monitoring with automatic response capabilities. In other words, the housing 105 may be designed for deployment for long durations, and/or in subsurface conditions, such as those involving a high pressure and high temperature, or underwater under high pressure, in accordance with one or more embodiments.

As illustrated in FIG. 1A, the LIBS sensing system 100 includes a laser module 110 operationally connected to a power driver 120 (can be referred to herein as a laser diode driver 120), which may be powered by a power source 130, such as batteries, including lithium-ion batteries, or other electrochemical energy sources. Alternative power sources may include supercapacitors, fuel cells, or hybrid battery systems combining lithium-ion with ultracapacitors for enhanced power delivery during high-energy pulse generation.

In one or more embodiments, the power drive 120 is designed such that it provides the necessary current and voltage to operate diode lasers (such as diode lasers 114 in the laser module 110), which require a constant current for stable operation. In various embodiments, the power driver 120 includes feedback loops to monitor and maintain the constant output current. n various embodiments, the power driver 120 is capable of delivering short, high-current pulses, suitable for side pumping of Nd:YAG rod in a few hundreds of microseconds. In one or more embodiments, the LIBS sensing system 100 is sealed in a cylindrical metal housing with outer diameter of 3˜4 inches and length of 10˜12 inches, suitable for field applications in harsh environments for deployment for long durations, especially in subsurface conditions involving high pressure and high temperature.

As shown in FIG. 1A, the LIBS sensing system 100 further includes an optical module 140 configured to work with one or more detectors 150 (e.g., photo detectors, etc.) and a computing module 160 (can be referred to herein as a computing unit 160), which may comprise, or coupled to, a data storage (not shown). In other words, the LIBS sensing system 100 includes the laser module 110, the power driver 120, the power source 130, the optical module 140, the detectors 150, and the computing module 160 within the housing 105, as illustrated in FIG. 1A.

In one or more embodiments, the computing module 160 included in the LIBS sensing system 100 may be embedded or integrated with other electronic components/units, including the detectors 150 and related integrated circuits (ICs). In one or more embodiments, the computing module 160 may be used for conversion for analog signals (e.g., signals from a photomultiplier tube (PMT) to digital signals and for storing such data locally inside the LIBS sensing system 100 using a data storage, such as, e.g., a micro Secure Digital (MicroSD™) card or electrically erasable programmable read-only memory (EEPROM). Data storage and processing capabilities may be expanded through the use of solid-state drives (SSDs), embedded flash memory arrays, or cloud connectivity for remote data storage and analysis. The embedded processing system may incorporate field-programmable gate arrays (FPGAs) or dedicated digital signal processors (DSPs) for real-time spectral analysis.

FIG. 1B shows components of the laser module 110 of the LIBS sensing system 100 in more detail via a perspective view 110-1 and an exploded perspective view 110-2. As shown in the exploded perspective view 110-2, the laser module 110 includes a neodymium-doped yttrium aluminum garnet (Nd:YAG) rod 112, a plurality of diode lasers 114, and a plurality of reflectors 116 (e.g., reflective mirrors 116). In one or more implementations, the laser module 110 may be configured as a source for a laser-induced plasma needed for laser induced breakdown spectroscopic sensing as disclosed herein. In addition, the laser module 110 of the LIBS sensing system 100 may be used and applied for many other spectroscopic applications, such as laser-induced incandescence (LII) studies.

As further illustrated in FIG. 1B, the laser module 110 includes an output coupler 117, a chromium yttrium aluminum garnet (Cr:YAG) crystal 118, and a high end-reflector 119, all of which are assembled with the Nd:YAG rod 112, diode lasers 114, and reflectors 116. In one or more embodiments of the laser module 110, the plurality of diode lasers 114 may be placed radially surrounding the Nd:YAG rod 112 such that the diode lasers 114 can generate light having a spectral band width that overlaps absorption bands of neodymium. In other words, the laser module 110 includes a configuration of a diode side-pumped passive Q-switch Nd:YAG laser system in which the diode lasers 114 generate specific wavelengths of light that overlap the absorption bands of neodymium in the Nd:YAG rod 112.

In one or more embodiments, the Cr:YAG crystal 118, also known as passive Q-switch, is used as a saturable absorber to achieve high peak laser power with short pulse width without requiring active control mechanisms, (e.g., acousto-optic or electro-optic modulator). As the laser module 110 of the LIBS sensing system 100 is pumped, energy accumulates in the gain medium. The saturable absorber, such as the Cr:YAG crystal 118 remains opaque until the intensity reaches a certain threshold. Once the energy exceeds the threshold, it becomes transparent, allowing a rapid release of stored lasing energy in the form of a high-intensity pulse. In one or more implementations, the laser module 110 of the LIBS sensing system 100 may be configured to produce a 6-nanosecond laser pulse with a pumping duration of a few hundred microseconds. In one or more embodiments, the Cr:YAG crystal 118 enables elimination of the need for complex electronic or active components, making the LIBS sensing system 100 more robust and easier to operate, especially for remote applications.

In one or mor embodiments, the laser module 110 of the LIBS sensing system 100 may be configured to produce several megawatts of peak power output (e.g., 3 megawatts). In various embodiments, this amount of output peak power can be done with 15˜20 mJ per pulse laser energy, for example, at a wavelength of 1064 nm. In various embodiments, the laser system may be configured to produce different peak power outputs ranging from 1 megawatt to 5 megawatts, with pulse energies adjustable between 10 mJ to 30 mJ per pulse. In various embodiments, the LIBS sensing system 100 may be configured to work at different wavelengths, including 532 nm, 266 nm, etc. The wavelength output may be varied through frequency doubling or tripling techniques to produce 532 nm or 355 nm outputs, respectively, for applications requiring different spectral characteristics.

In one or mor embodiments, the diode lasers 114 may be configured in a specific radial configuration for side-pumping of the Nd:YAG rod 112 such that the diode lasers 114 can provide a good output beam profile with a low M² value (e.g., M² value of less than 1.5). In some embodiments, the M² value may be further optimized to achieve values less than 1.2 through enhanced beam shaping optics or adaptive beam correction systems.

In one or more embodiments, the diode lasers 114 may include one or more 808-nm diode laser bars, each of which may produce an output power of a few hundreds of watts per centimeter. In one or more embodiments, the diode lasers 114 may be configured to produce a spectral width of about 2 nm to about 5 nm and may be temperature-tuned to spectrally overlap with the absorption bands of neodymium in the Nd:YAG rod 112. The diode lasers 114 may be configured to operate at wavelengths including 885 nm, 940 nm, or other wavelengths within the neodymium absorption spectrum, with spectral widths ranging from 1 nm to 10 nm depending on the specific application requirements. In some embodiments, wavelength-stabilized diode lasers 114 with temperature control may be employed to maintain consistent spectral overlap with neodymium absorption bands across varying environmental conditions. In other words, considering both the spectral bands overlapping and high electrical efficiency (40˜60%), the diode lasers 114 may be an efficient pump source for Nd:YAG-based lasers, such as the disclosed laser module 110 based on the Nd:YAG rod 112.

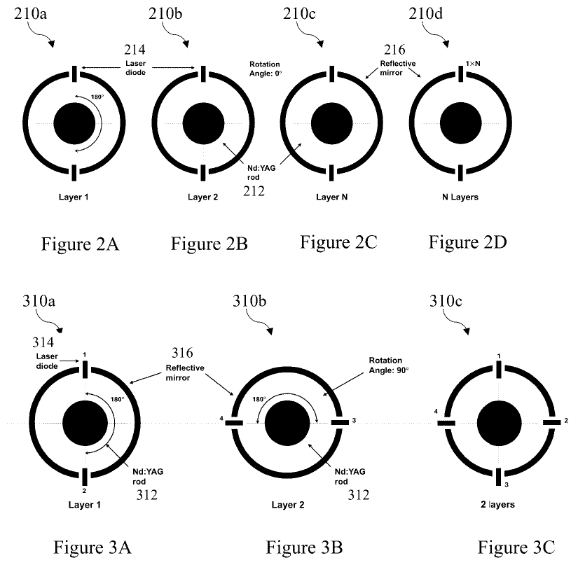

An example arrangement of diode lasers 114 for optical side-pumping of the Nd:YAG rod 112 in the laser module 110 is depicted in FIG. 1B. As shown in the exploded perspective view 110-2, the laser module 110 employs a configuration in which three diode lasers 114 disposed in-between reflectors 116 in each layer of the three-layer configuration. Additional diode pumping configurations for optical side-pumping of the Nd:YAG rod 112 are described with respect to FIGS. 2-10, as further discussed below. In accordance with various implementations herein, the disclosed configurations enable a uniform pump light from the diode lasers 114 to enter the side of the Nd:YAG rod 112 along an entire length of the rod, which results in a good output beam profile from the laser module 110 with relatively a low M² value.

FIG. 1C depicts a schematic depiction of the LIBS plasma emission detection mechanism of the LIBS sensing system 100, in accordance with various embodiments. As disclosed herein, the LIBS sensing system 100 employs a focused, pulsed laser beam generated from the laser module 110 and guides the beam using the optical module 140 to create a temporary, high-temperature micro-plasma 102 (also referred to herein as a plasma plume 102) on a sample's surface. As a high-energy laser pulse is focused at the sample using a focal lens, the high energy within a finite volume causes localized heating, resulting in the formation of a plasma, such as the plasma plume 102. As the plasma cools down, it emits light at characteristic wavelengths corresponding to the elements present in the sample. This light is then captured using the optical module 140 and the detectors 150 (including detectors 150-1, 150-2, and 150-3) at unique wavelengths corresponding to the sample's constituent elements, including elemental composition and trace species concentration of the sample. In other words, the emitted light from the plasma plume 102 is collected using an optical tool, such as the optical module 140, and analyzed using spectral filters. The spectral signal provides information about the elemental composition and concentration.

As shown in FIG. 1C, the laser module 110 emits a laser beam having a wavelength, e.g., 1064 nm, through a dichroic mirror (DM1) and focused using a short focal lens (FL1) for laser induced breakdown emission studies. The reflected plasma emission is then collimated by the same focal lens and reflected by the dichroic mirror towards a detection path 104. A second dichroic mirror (DM2) is used to separate the LIBS signal (i.e., plasma emissions) from the remaining laser beam (e.g., 1064 nm beam) reflected by the first focal lens (FL1) in the laser path, which is used to trigger/time the occurrence of output laser pulse by photodetector detector 150-1, and therefore to synchronize with the data acquisition. The LIBS signal is further divided into two legs after a long-wavelength pass filter LPF (or a short-wavelength pass filter). In each leg, a band-pass filter (BPF) may be applied in front of the detector to receive the LIBS signal at desired the wavelength region. The wavelengths of the band-pass filters are determined by the emission lines of the target elements. By using photomultiplier tubes as the detectors at detector 150-2 and detector 150-3, the detection limit can be extended to a few tens of parts per million (PPM) level, in accordance with various embodiments described herein.

The detection sensitivity of the detectors 150-2 and 150-3 may be enhanced through the use of avalanche photodiodes (APDs), silicon photomultipliers (SiPMs), or hybrid detector arrays that combine multiple detection technologies. Detection limits of the detectors 150-2 and 150-3 may be improved to sub-ppm levels (parts per billion) through advanced signal processing algorithms, longer integration times, or multi-pulse averaging techniques. The detector configuration for each of the detectors 150-2 and 150-3 may include multiple spectral channels with different bandpass filters optimized for specific elemental detection, or tunable filters that can be adjusted in real-time for different analytical targets.

In one or more implementations, the photomultiplier tube (PMT) signals from the detectors 150-2 and 150-3 may be exported by the computing module 160 and converted from the analog signals to digital signals using an on-board analogy-to-digital converter (ADC) and stored in the data storage, in one or more implementations. The additional components accompanying the PMTs may include a built-in high-voltage power supply, transimpedance amplifier (if PMT outputs current readout), various resistors and capacitors for signal conditioning, and an external memory, such as, a microSD card or EEPROM. In various implementations, the PMT signals can be automatically converted to digital values and stored in an array at regular intervals from seconds up to hours.

In one or more implementations, the diode lasers 114 (also referred to herein as diode laser bars 114) can be configured for side pumping of the Nd:YAG rod 112 with uniformly pumped light distributions and high quality pulse laser outputs with low M² value. In general, more diode laser bars provide more pumping power. The arrangement of these diode bars is determined by the requirements of output energy and output beam profile. Similar to the exploded perspective view 110-2 in FIG. 1B, which shows the laser module 110 in a configuration in which three diode lasers 114 disposed in-between reflectors 116 in each layer of the three-layer configuration, FIGS. 2-10 illustrate various configurations of the diode lasers 114 (also referred to as diode laser bars 114) and reflectors 116 (also referred to as reflective mirrors 116) in cross-sectional views.

FIGS. 2A, 2B, 2C, and 2D illustrate an example embodiment of the laser module 110 in cross-sectional views 210a, 210b, 210c, and 210d, respectively, in accordance with various embodiments. As depicted in the cross-sectional views 210a, 210b, 210c, and 210d, the configuration shows two diode lasers 214 per layer arrangement with multiple layers stacked together in a stacked layer configuration. For each layer, two diode lasers 214 are aligned in a line on each side of the Nd:YAG rod 212. A pair of reflective mirrors 216 (e.g., cylindrical concave mirrors) are used to reflect the pumping light and therefore increase the light absorption efficiency of the Nd:YAG rod 212. In one or more implementations, multiple layers (N=2˜6) may be stacked together covering a major part of the Nd:YAG rod 212 along its length. FIGS. 2A, 2B, 2C, and 2D show one way to stack N layers together with 0° rotational angle between each layer. In general, more layers stack together with a designed rotational angle shift between layers will perform more uniformly light pumping. Specifically, the rotational angle is determined by the number of bars per layer and the total number of layers (360°/#of bars per layer/#of layers).

FIGS. 3A, 3B, and 3C illustrate an example embodiment of the laser module 110 in cross-sectional views 310a, 310b, and 310c, respectively, in accordance with various embodiments. FIGS. 3A and 3B show a two-layer (360°/2/2=90°) configuration with a rotational angle of 90° between two diode lasers 314, and consequently, reflective mirrors 316, between different layers. FIG. 3C shows the cross-sectional view 310c of the combined two layers with two diode lasers 314 from the first layer offsetting those in the second layer when viewed down the length of the Nd:YAG rod 312.

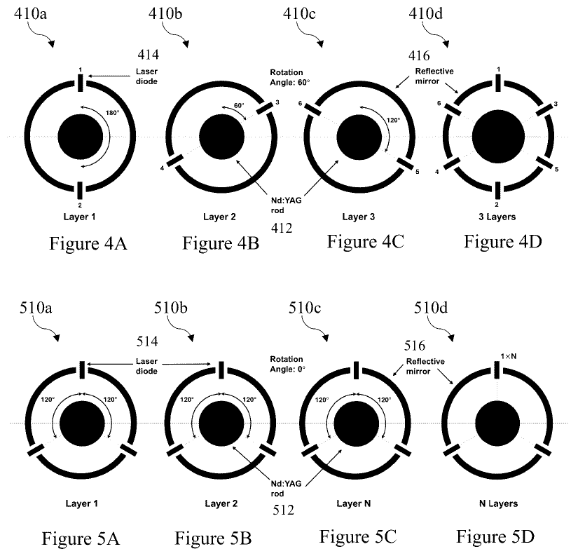

Similarly, FIGS. 4A, 4B, 4C, and 4D illustrate an example embodiment of the laser module 110 in cross-sectional views 410a, 410b, 410c, and 410d, respectively, in accordance with various embodiments. FIGS. 4A, 4B, and 4C show a three-layer (360°/2/3=60°) configuration with a rotational angle 60° between two diode lasers 414, and consequently, reflective mirrors 416, between different layers. FIG. 4D shows the cross-sectional view 410d of the combined three layers with two diode lasers 414 from each of the layers offsetting those in the other layers when viewed down the length of the Nd:YAG rod 412.

FIGS. 5A, 5B, 5C, and 5D illustrate an example embodiment of the laser module 110 in cross-sectional views 510a, 510b, 510c, and 510d, respectively, in accordance with various embodiments. As depicted in the cross-sectional views 510a, 510b, 510c, and 510d, the configuration shows three diode lasers 514 per layer arrangement with multiple layers stacked together in a stacked layer configuration. For each layer, three diode lasers 514 are evenly placed around the Nd:YAG rod 512. Three reflective mirrors 516 (e.g., cylindrical concave mirrors) are placed between three diode lasers 514 for reflection of pumping light source and therefore increase the light absorption efficiency of the Nd:YAG rod 512. In one or more implementations, multiple layers (N=2˜6) may be stacked together covering a major part of the Nd:YAG rod 512 along its length. FIGS. 5A, 5B, 5C, and 5D show one way to stack N layers together with 0° rotational angle between each layer.

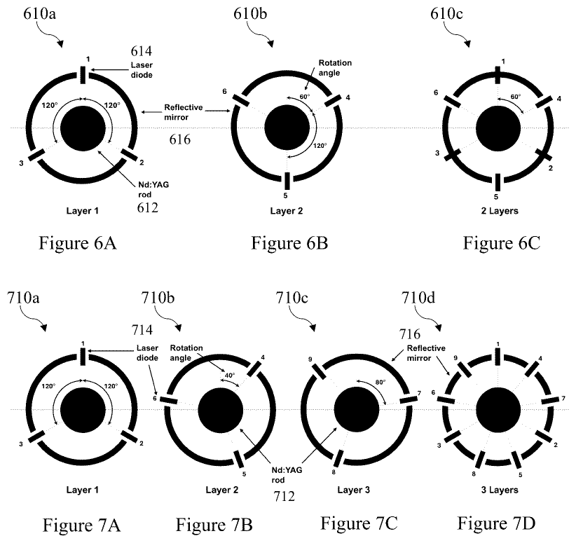

FIGS. 6A, 6B, and 6C illustrate an example embodiment of the laser module 110 in cross-sectional views 610a, 610b, and 610c, respectively, in accordance with various embodiments. FIGS. 6A and 6B show a two-layer (360°/3/2=60°) configuration with a rotational angle of 60° between three diode lasers 614, and consequently, reflective mirrors 616, between different layers. FIG. 6C shows the cross-sectional view 610c of the combined two layers with three diode lasers 614 from each layer offsetting those in the other layers when viewed down the length of the Nd:YAG rod 612.

FIGS. 7A, 7B, 7C, and 7D illustrate an example embodiment of the laser module 110 in cross-sectional views 710a, 710b, 710c, and 710d, respectively, in accordance with various embodiments. FIGS. 7A, 7B, and 7C show a three-layer (360°/3/3=40°) configuration with a rotational angle 40° between three diode lasers 714, and consequently, reflective mirrors 716, between different layers. FIG. 7D shows the cross-sectional view 710d of the combined three layers with three diode lasers 714 from each of the layers offsetting those in the other layers when viewed down the length of the Nd:YAG rod 712.

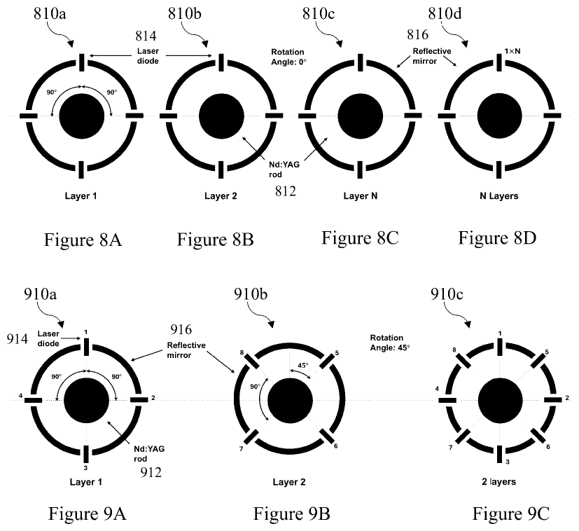

FIGS. 8A, 8B, 8C, and 8D illustrate an example embodiment of the laser module 110 in cross-sectional views 810a, 810b, 810c, and 810d, respectively, in accordance with various embodiments. As depicted in the cross-sectional views 810a, 810b, 810c, and 810d, the configuration shows four diode lasers 814 per layer arrangement with multiple layers stacked together in a stacked layer configuration. For each layer, four diode lasers 814 are evenly placed around the Nd:YAG rod 812. Four reflective mirrors 816 (e.g., cylindrical concave mirrors) are placed between four diode lasers 814 for reflection of pumping light source and therefore increase the light absorption efficiency of the Nd:YAG rod 812. In one or more implementations, multiple layers (N=2˜6) may be stacked together covering a major part of the Nd:YAG rod 812 along its length. FIGS. 8A, 8B, 8C, and 8D show one way to stack N layers together with 0° rotational angle between each layer.

FIGS. 9A, 9B, and 9C illustrate an example embodiment of the laser module 110 in cross-sectional views 910a, 910b, and 910c, respectively, in accordance with various embodiments. FIGS. 9A and 9B show a two-layer (360°/4/2=45°) configuration with a rotational angle of 45° between four diode lasers 914, and consequently, reflective mirrors 916, between different layers. FIG. 9C shows the cross-sectional view 910c of the combined two layers with four diode lasers 914 from each layer offsetting those in the other layers when viewed down the length of the Nd:YAG rod 912.

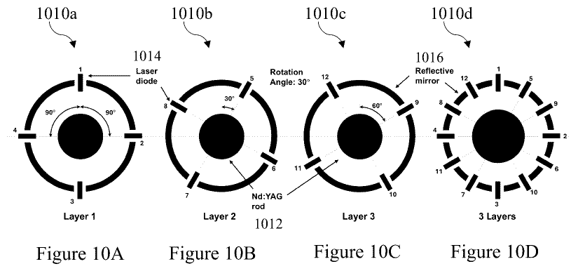

FIGS. 10A, 10B, 10C, and 10D illustrate an example embodiment of the laser module 110 in cross-sectional views 1010a, 1010b, 1010c, and 1010d, respectively, in accordance with various embodiments. FIGS. 10A, 10B, and 10C show a three-layer (360°/4/3=30°) configuration with a rotational angle 30° between four diode lasers 1014, and consequently, reflective mirrors 1016, between different layers. FIG. 10D shows the cross-sectional view 1010d of the combined three layers with four diode lasers 1014 from each of the layers offsetting those in the other layers when viewed down the length of the Nd:YAG rod 1012.

As discussed with respect to FIGS. 2-10 above, the diode lasers and reflective mirrors shown in the cross-sectional views are positioned radially about the Nd:YAG rod at equidistant from one another. In other words, the diode lasers (and reflective mirrors) are positioned about the Nd:YAG rod in a stacked layer configuration having at least two layers stacked along a length of the Nd:YAG rod, in some embodiments. Furthermore, each of the at least two layers comprises at least two diode lasers positioned at equidistant radially from one another within the layer. In one or more embodiments, the at least two diode lasers in adjacent layers of the at least two layers may be staggered such that the at least two diode lasers in a first layer is staggered with respect to the at least two diode lasers in a second layer. In one or more embodiments, the stacked layer configuration may include three layers along the length of the Nd:YAG rod, wherein each of the three layers may include three diode lasers that are positioned at 120 degrees radially apart from one another within the layer. In one or more embodiments, three diode lasers of a first layer of the three layers may be staggered with respect to three diode lasers of a second layer of the three layers.

Using the stacked layer configurations described with respect to FIGS. 1-10, the output energy of the laser module 110 of the LIBS sensing system 100 may be about 17˜20 mJ per pulse with the repetition rate of 2 Hz using three-diode laser and four-diode laser per layer configurations. In some embodiments, the wavelength of the output beam is 1064 nm and the pulse width is 6 ns at full width of half maximum (FWHM). The output of 17˜20 mJ per pulse is about three times more than commercially available laser sources at 5˜6 mJ per pulse. With a configuration of nine diode lasers, the laser output beam quality is excellent with low M² value (˜1.3), also known as the beam quality factor, which is a critical parameter in laser optics that quantifies how close the beam is to an ideal Gaussian beam (M²=1). The M² value affects the focus ability of the laser beam, which is important for LIBS sensing. In LIBS sensing applications, a lens, such as those in the optical module 140, may be used to focus the laser beam into a point to produce peak intensity needed to generate a plasma through multiphoton ionization and avalanche ionization processes.

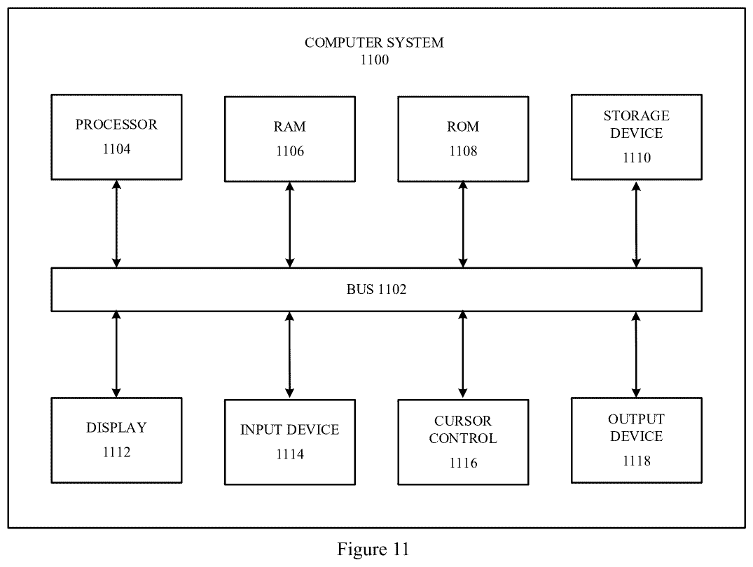

FIG. 11 depicts a block diagram illustrating an example computer system 1100, with which embodiments of the disclosed system and method may be implemented, in accordance with various embodiments. For example, the illustrated computer system 1100 can be a local or remote computer system operatively connected to the disclosed system and method for performing imaging operations, such as those described with respect to FIGS. 1-10.

In various embodiments of the present teachings, computer system 1100 can include a bus 1102 or other communication mechanism for communicating information and a processor 1104 coupled with bus 1102 for processing information. In various embodiments, computer system 1100 can also include a memory, which can be a random-access memory (RAM) 1106 or other dynamic storage device, coupled to bus 1102 for determining instructions to be executed by processor 1104. Memory can also be used for storing temporary variables or other intermediate information during execution of instructions to be executed by processor 1104. In various embodiments, computer system 1100 can further include a read only memory (ROM) 1108 or other static storage device coupled to bus 1102 for storing static information and instructions for processor 1104. A storage device 1110, such as a magnetic disk or optical disk, can be provided and coupled to bus 1102 for storing information and instructions.

In various embodiments, computer system 1100 can be coupled via bus 1102 to a display 1112, such as a cathode ray tube (CRT) or liquid crystal display (LCD), for displaying information to a computer user. An input device 1114, including alphanumeric and other keys, can be coupled to bus 1102 for communication of information and command selections to processor 1104. Another type of user input device is a cursor control 1116, such as a mouse, a trackball or cursor direction keys for communicating direction information and command selections to processor 1104 and for controlling cursor movement on display 1112. This input device 1114 typically has two degrees of freedom in two axes, a first axis (i.e., x) and a second axis (i.e., y), that allows the device to specify positions in a plane. However, it should be understood that input devices 1114 allowing for 3-dimensional (x, y and z) cursor movement are also contemplated herein. In accordance with various embodiments, components 1012/1114/1116, together or individually, can make up a control system that connects the remaining components of the computer system to the systems herein and methods conducted on such systems, and controls execution of the methods and operation of the associated system.

In various embodiments, the computer system 1100 includes an output device 1118. In various embodiments, the output device 1118 can be a wireless device, a computing device, a portable computing device, a communication device, a printer, a graphical user interface (GUI), a gaming controller, a joy-stick controller, an external display, a monitor, a mixed reality device, an artificial reality device, or a virtual reality device.

Consistent with certain implementations of the present teachings, results can be provided by computer system 1100 in response to processor 1104 executing one or more sequences of one or more instructions contained in memory 1106. Such instructions can be read into memory 1106 from another computer-readable medium or computer-readable storage medium, such as storage device 1110. Execution of the sequences of instructions contained in memory 1106 can cause processor 1104 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, etc.) or “computer-readable storage medium” as used herein refers to any media that participates in providing instructions to processor 1104 for execution. Such a medium can take many forms, including but not limited to, non-volatile media, volatile media, and transmission media. Examples of non-volatile media can include, but are not limited to, dynamic memory, such as memory 1106. Examples of transmission media can include, but are not limited to, coaxial cables, copper wire, and fiber optics, including the wires that comprise bus 1102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, another memory chip or cartridge, or any other tangible medium from which a computer can read.

In addition to computer-readable medium, instructions or data can be provided as signals on transmission media included in a communications apparatus or system to provide sequences of one or more instructions to processor 1104 of computer system 1100 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, etc.

It should be appreciated that the methodologies described herein, flow charts, diagrams and accompanying disclosure can be implemented using computer system 1100 as a standalone device or on a distributed network or shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1100, whereby processor 1104 would execute the analyses and determinations provided by these engines, subject to instructions provided by any one of, or a combination of, memory components 106/1108/1110 and user input provided via input device 1114.

While the present teachings are described in conjunction with various embodiments, it is not intended that the present teachings be limited to such embodiments. On the contrary, the present teachings encompass various alternatives, modifications, and equivalents, as will be appreciated by those of skill in the art. In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

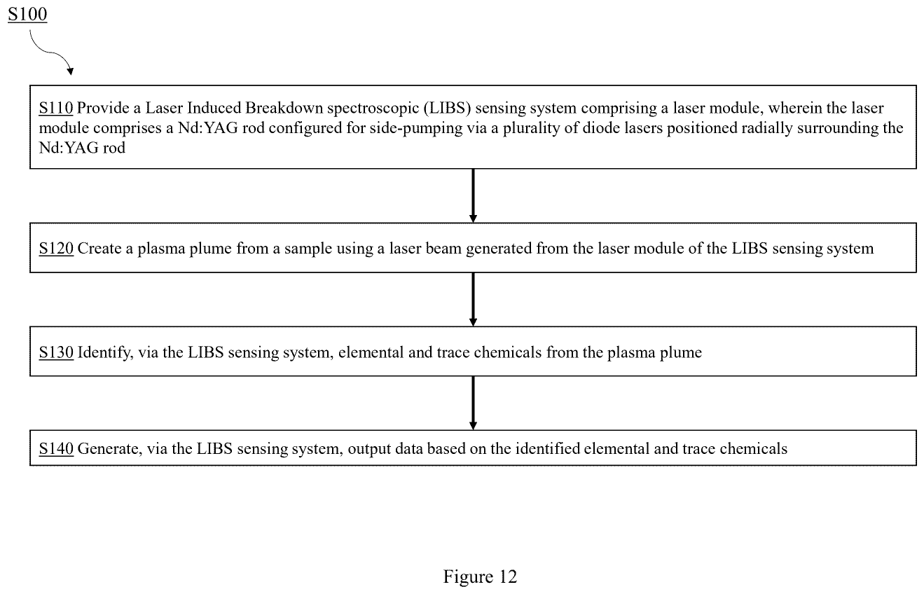

FIG. 12 illustrates a flowchart of a method S100 for spectroscopic sensing, in accordance with one or more embodiments. In one or more embodiments, the method S100 may be used for chemical and molecular species detections and trace concentration measurements, as disclosed herein. As illustrated in FIG. 12, the method S100 includes, at step S110, providing a Laser Induced Breakdown spectroscopic (LIBS) sensing system comprising a laser module, wherein the laser module comprises a Nd:YAG rod configured for side-pumping via a plurality of diode lasers positioned radially surrounding the Nd:YAG rod; at step S120, creating a plasma plume from a sample using a laser beam generated from the laser module of the LIBS sensing system; at step S130, identifying, via the LIBS sensing system, elemental and trace chemicals from the plasma plume; and at step S140, generating, via the LIBS sensing system, output data based on the identified elemental and trace chemicals.

In one or more embodiments of the method S100, identifying the elemental and trace chemicals from the plasma plume may include spectral analysis of the plasma plume via a spectral filter or one or more detectors each comprising a photomultiplier tube.

In one or more embodiments, the LIBS sensing system may include a housing, the laser module, a detector module, a computing module, and a battery module. In one or more embodiments, the laser module, the detector module, the computing module, and the battery module may be disposed within the housing. In one or more embodiments, the housing may include an optical window that allows transmission of the laser beam from the laser module and reception of an emitted light from the plasma plume.

In one or more embodiments of method S100, the plurality of diode lasers may be positioned radially about the Nd:YAG rod at equidistant from one another. In one or more embodiments, the plurality of diode lasers may be positioned about the Nd:YAG rod in a stacked layer configuration having at least two layers along a length of the Nd:YAG rod, wherein each of the at least two layers comprises at least two diode lasers positioned at equidistant radially from one another within the layer. In one or more embodiments, the at least two diode lasers in adjacent layers of the at least two layers may be staggered such that the at least two diode lasers in a first layer is staggered with respect to the at least two diode lasers in a second layer. In one or more embodiments, the stacked layer configuration may include three layers along the length of the Nd:YAG rod, wherein each of the three layers may include three diode lasers that are positioned at 120 degrees radially apart from one another within the layer. In one or more embodiments, three diode lasers of a first layer of the three layers may be staggered with respect to three diode lasers of a second layer of the three layers.

In one or more embodiments of method S100, the laser module may include a Cr:YAG crystal, which functions as a passive Q-switch or a saturable absorber. In one or more embodiments, the Cr:YAG crystal may be disposed at one end of the Nd:YAG rod.

What is claimed is:

1. A system, comprising:
a laser module configured for producing a laser beam capable of creating a plasma plume of a sample, the laser module comprising a Nd:YAG rod and a plurality of diode lasers that are placed radially surrounding the Nd:YAG rod,
wherein the plurality of diode lasers are configured to generate light having a spectral band width that overlaps absorption bands of Nd;
a detector module configured for identifying elemental and trace chemicals from the plasma plume; and
a computing module configured to acquire, store, and/or output data from the detector module.

2. The system of claim 1, wherein the detector module comprises a spectral filter configured for spectral analysis of the plasma plume.

3. The system of claim 1, wherein the detector module comprises a plurality of detectors, and wherein each detector comprises a photomultiplier tube.

4. The system of claim 1, further comprising:
a housing, wherein the laser module, the detector module, and the computing module are disposed within the housing.

5. The system of claim 4, wherein the housing comprises an opening that allows transmission of the laser beam from the laser module and reception of an emitted light from the plasma plume.

6. The system of claim 5, further comprising:
an optical window disposed within the opening of the housing, wherein the optical window is transparent to both the laser beam from the laser module and the emitted light from the plasma plume.

7. The system of claim 1, further comprising:
a battery module comprised within the housing, the battery module configured to provide power to the laser module, the detector module, and the computing module.

8. The system of claim 1, wherein the plurality of diode lasers are positioned radially surrounding the Nd:YAG rod and spaced apart at equidistant from one another.

9. The system of claim 1, wherein the plurality of diode lasers are positioned about the Nd:YAG rod in a stacked layer configuration having at least two layers along a length of the Nd:YAG rod, and wherein each of the at least two layers comprises at least two diode lasers positioned at equidistant radially from one another within the layer.

10. The system of claim 9, wherein the at least two diode lasers in adjacent layers of the at least two layers are staggered such that the at least two diode lasers in a first layer is staggered with respect to the at least two diode lasers in a second layer.

11. The system of claim 9, wherein the stacked layer configuration comprises three layers along the length of the Nd:YAG rod, wherein each of the three layers comprises three diode lasers that are positioned at 120 degrees radially apart from one another within the layer.

12. The system of claim 11, wherein three diode lasers of a first layer of the three layers are staggered with respect to three diode lasers of a second layer of the three layers.

13. The system of claim 1, wherein the laser module further comprises a passive Q-switch configured as a saturable absorber.

14. The system of claim 1, wherein the passive Q-switch comprises a Cr:YAG crystal, wherein the Cr:YAG crystal is disposed at one end of the Nd:YAG rod.

15. A method, comprising:
providing a Laser Induced Breakdown spectroscopic (LIBS) sensing system comprising a laser module, wherein the laser module comprises a Nd:YAG rod configured for side-pumping via a plurality of diode lasers positioned radially surrounding the Nd:YAG rod;
creating a plasma plume from a sample using a laser beam generated from the laser module of the LIBS sensing system;
identifying, via the LIBS sensing system, elemental and trace chemicals from the plasma plume; and
generating, via the LIBS sensing system, output data based on the identified elemental and trace chemicals.

16. The method of claim 15, wherein identifying the elemental and trace chemicals from the plasma plume comprises spectral analysis of the plasma plume via a spectral filter or one or more detectors each comprising a photomultiplier tube.

17. The method of claim 15, wherein the LIBS sensing system comprises a housing, the laser module, a detector module, a computing module, and a battery module, wherein the laser module, the detector module, the computing module, and the battery module are disposed within the housing.

18. The method of claim 15, wherein the plurality of diode lasers are positioned radially about the Nd:YAG rod at equidistant from one another.

19. The method of claim 15, wherein the plurality of diode lasers are positioned about the Nd:YAG rod in a stacked layer configuration having at least two layers along a length of the Nd:YAG rod, wherein each of the at least two layers comprises at least two diode lasers positioned at equidistant radially from one another within the layer.

20. The method of claim 19, wherein the at least two diode lasers in adjacent layers of the at least two layers are staggered such that the at least two diode lasers in a first layer is staggered with respect to the at least two diode lasers in a second layer.
